(19) United States
(12) Patent Application Publication
(10) Pub. No.: US 2006/0171287 A1
(43) Pub. Date: Aug. 3, 2006

(54) Rewritable data carrier

(76) Inventors: Bart Van Rompaey, EINDHOVEN (NL); Wilhelmus Robert Koppers, Eindhoven (NL); Hermanus Johannes Borg, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,372

(22) PCT Filed: Mar. 8, 2004
(86) PCT No.: PCT/IB04/00730

§ 371 Date: Sep. 14, 2005

(30) Foreign Application Priority Data
Mar. 17, 2003 (EP) 03290670.3

(51) Int. Cl. G11B 7/24

(52) U.S. Cl. 369/275.1

(57) ABSTRACT

The invention relates to a data carrier comprising a first area (12) comprising a rewritable material, said first area being defined as a read-only area by means of type information recorded on said data carrier in an unerasable way.

### FIELD OF THE INVENTION

The present invention relates to a data carrier comprising a rewritable material.

The present invention is particularly relevant for optical data storage and optical disc apparatuses for recording data on recordable discs, particularly portable devices.

### BACKGROUND OF THE INVENTION

In optical storage, three types of data carrier exist. A read only data carrier (hereinafter referred as ROM data carrier, which stands for Read Only Memory) can only be read by a user. Such a ROM data carrier usually comprises pits and lands, which are manufactured by means of a stamper. If a manufacturer wants to provide a ROM content to a user, a stamper has to be manufactured for this content, which is difficult to manufacture and expensive, especially if the number of data carriers manufactured with this stamper is low, which is the case if the content changes rapidly, for example each month. In order to avoid the use of a stamper, a manufacturer who wants to provide a ROM content to a user can use a write-once data carrier (hereinafter referred as WORM data carrier, which stands for Write Once Read Many). Such a WORM data carrier comprises a WORM material, which can be degraded by means of an optical beam in order to write a pit pattern, which comprises the provided content. A drawback of such a WORM data carrier lies in the fact that, once the content has been recorded on the data carrier, this content cannot be changed. As a consequence, if an error occurs during writing or if the content has become obsolete just before providing it to the user, the manufacturer cannot change the written content and has to throw the data carrier away. Moreover, it is difficult in this case for a manufacturer to provide a ROM content as well as a rewritable area on the data carrier, which rewritable area can be used by a user in order to record his own data. Actually, manufacturing a data carrier comprising a WORM material and a RW material is difficult, especially because the same material cannot be used as WORM and RW.

In order to avoid these drawbacks, a solution consists in using a rewritable data carrier (hereinafter referred as RW data carrier). Such a RW data carrier usually comprises a phase-change optical recording material. Writing on a phase-change optical recording material by means of an optical beam is based on a transformation between a crystalline and a non-crystalline phase or between two different crystalline phases. Data can thus be written on the recording material, then easily erased by means of the optical beam and rewritten. If the manufacturer wants to provide a ROM content to the users, he can define at least a part of the data carrier as a ROM area. U.S. Pat. No. 5,323,380 describes a disc comprising RW and ROM areas, wherein some ROM areas are RW areas which have been defined as ROM areas.

In this patent, the type of an area, i.e. RW or ROM, is defined by means of a flag, which is recorded in a recording area. When a provider, such as a value added re-selling vendor, has recorded data, such as traffic information, in an area which he wants to be provided as ROM area to the users, he sets the flag identifying said area, to a value corresponding to the ROM type. Then, when a user wants to record data on this data carrier by means of a recorder, the flags are read by the recorder, which thus receives an indication that no data can be recorded in the areas defined as ROM.

However, a drawback of such a data carrier lies in the fact that it can easily be hacked. Actually, a hacker can modify a firmware of his recorder, so that the flags of the data carrier are not read. In this case, the hacker can erase all the data written on the data carrier, including the flags, because the flag are written in a RW area. Then, the hacker can distribute the hacked data carriers to other users, which can use these hacked data carriers as conventional RW data carriers, because the flags identifying ROM areas have been erased.

### SUMMARY OF THE INVENTION

It is an object of the invention to provide a data carrier, in which the problems described above are eliminated.

To this end, the invention proposes a data carrier comprising a first area comprising a rewritable material, said first area being defined as a read-only area by means of type information recorded on said data carrier in an unerasable way.

According to the invention, an area is defined as a ROM area, by means of type information, which cannot be erased by means of an optical beam. As a consequence, an area defined as a ROM area might be erased by a hacker having a recorder with a modified firmware, which recorder can erase data without reading the type information. But in this case, a user receiving such a hacked data carrier from the hacker cannot use it as a conventional RW data carrier on a conventional recorder, because the area defined as ROM area by the manufacturer is still defined as a ROM area, as the type information has not been erased.

In an advantageous embodiment, the data carrier further comprises a second area comprising a rewritable material, said first and second areas being parts of a same layer of said data carrier. According to this embodiment, a one-layer data carrier can be manufactured, which comprises a same RW material on the whole layer, and which has a ROM area and a RW area. Such a data carrier is easy to manufacture, and is particularly advantageous for a provider. Actually, a provider can provide a ROM content to a user, said ROM content comprising, for example, advertisements. A user will be particularly interested in acquiring such a data carrier, because it comprises an area where he can record his own data. Such a data carrier might be distributed free of charge or at a low price, thanks to the advertisements recorded in the data carrier. This will even increase the interest of the user. Moreover, as this data carrier cannot be hacked, the provider will not hesitate to distribute it at a low price.

Preferably, the data carrier comprises a central part, the first area being nearer to said central part than the second area. In this way, a user can record data on the data carrier even with a portable device, in which the available power is relatively low. Actually, in optical discs, for a given recording speed, i.e. a given linear recording velocity, writing in outer regions of a disc requires a lower speed of rotation of the disc than for writing in inner regions of a disc. As a consequence, if a user wants to write data in the second area with a portable device, the amount of power needed is less with the second area located in the outer regions of the disc than with the second area located in the inner regions of the disc.

In a preferred embodiment, the data carrier comprises a type area comprising said type information recorded by means of pits and lands. According to this embodiment, the type information can be recorded after the ROM content has been written in the data carrier by the manufacturer. For example, the type area comprises a WORM material, which is degraded by means of an optical beam in order to write the type information. As a consequence, the manufacturer can write the ROM content with a conventional recorder, because when writing the ROM content, the area in which this ROM content is written is not yet defined as a ROM area. Alternatively, the type information is written by means of a stamper in the type area. In this case, the type information is preferably recorded before the ROM content is written in the data carrier by the manufacturer.

In a more preferred embodiment, the type information is recorded by means of a frequency modulated wobble. A RW disc comprises a wobbled groove, which groove is used for tracking. The frequency modulated wobble comprises information, such as timing or address information of the tracks. As the wobbled groove cannot be erased by means of an optical beam, it can be used in order to write the type information. Before printing the wobbled groove on the disc, the manufacturer adds the type information in the wobble, so that this type information can be retrieved by a recorder, as the timing or address information comprised in the wobble. For example, in the case of a rewritable Compact Disc (hereinafter referred as CD-RW), the type information can be encoded as Absolute Time In Pre-groove data in the lead-in area of the CD-RW. In the case of a Blu-Ray disc (hereinafter referred as BD), the type information can be encoded as Permanent Information and Control data. In the case of a rewritable Digital Versatile Disc (DVD+RW), the type information can be encoded in the ADIP information in the lead-in zone of the DVD+RW (ADIP stands for Address In pre-Groove).

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a data carrier in accordance with the invention.

### DETAILED DESCRIPTION OF THE INVENTION

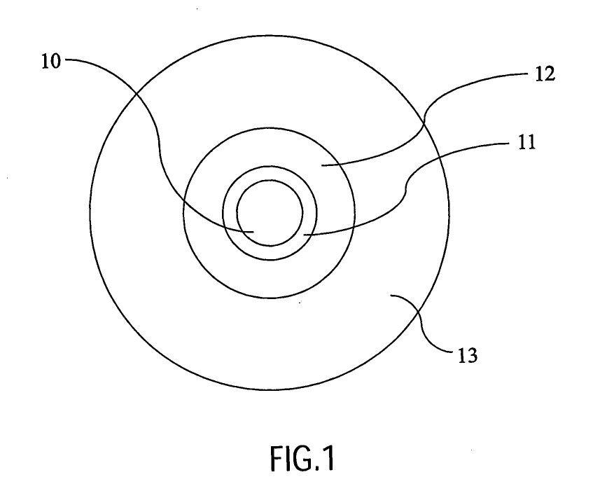

A data carrier in accordance with the invention is depicted in FIG. 1. Such a data carrier comprises a central hole 10, a type area 11, a first area 12 and a second area 13. The first and second areas 12 and 13 comprise the same RW material.

However, the invention is not limited to the use of a same RW material in the first and second areas 12 and 13. For example, different recording materials having different thermal properties suitable for writing at different recording speeds can be used. For example, the first area 12, which is defined as a ROM area as will be described hereinafter, might comprise a RW material suitable for writing at a relatively high recording speed, whereas the second area 13 might comprise a RW material suitable for writing at a relatively low recording speed. Actually, writing at a relatively high recording speed requires a relatively large amount of power. As the first area 12 is recorded by a manufacturer by means of a recorder powered by a main supply source, the amount of available power is relatively large, so that the first area 12 can be recorded at a relatively high recording speed. However, writing at a relatively low recording speed requires a lower amount of power. As a consequence, a user is able to record data in the second area 13, even if the amount of available power in the recorder is relatively low, which is the case in a battery-powered portable device for example.

Using the same RW material in the first and second areas 12 and 13 leads to an easy to manufacture data carrier. Actually, a data carrier as depicted in FIG. 1 can be manufactured using conventional techniques, such as the techniques used for manufacturing CD-RWs.

In the data carrier of FIG. 1, a type information is written in the type area 11, indicating that the first area 12 is defined as a ROM area. When a user wants to record data on this data carrier by means of a conventional recorder, the recorder reads the type area 11, which indicates that no data can be written in the first area 12. Hence, the recorder writes data only in the second area 13. A location of the first area 12 can be defined, for example, by means of timing or address information. For example, the location of the first area 12 is identified in the type area 11 by means of track numbers or addresses in a pre-groove.

A number of the first track and a number of the last track of the first area 12 are for example encoded in the type area 11. The type information concerning the first area 12 is recorded on the type area 11, associated with the location of the first area 12, i.e. the track numbers identifying the first area 12. The type information can be, for example, a bit or a set of bits indicating if the area associated to said type information is defined as ROM or not. Alternatively, the type information can comprise the type of an area as well as the location of said area.

The second area 13 might also be defined in the type area 11, and type information indicating that the second area 13 is a RW area might be recorded in the type area 11. However, it is also possible that an area of the data carrier has no associated type information. In this case, such an area is identified as a RW area.

Different embodiments of data carriers in accordance with the invention are given hereinafter.

In a first embodiment, the type area 11 comprises a WORM material. A manufacturer writes data in a part of the data carrier comprising the RW material, for example in the first area 12. Then, the location of the first area 12 is encoded and recorded in the type area 11, by degrading the WORM material in order to form pits and lands corresponding to said encoded location. Type information indicating that the first area is ROM is also recorded on the type area 11. As a consequence, the manufacturer can record data in the first area 12 by means of a conventional recorder. Actually, before writing data on the data carrier, the recorder reads the type area 11. As no type information is recorded in the type area 11, data can be written anywhere on the parts of the carrier comprising a RW material. Once the manufacturer has written data in the first area 12, the recorder is used to write the type information in the WORM type area 11.

In a second embodiment, the type area 11 is embossed by means of a stamper in order to form pits and lands in the type area 11. The manufacturer writes data in a part of the data carrier comprising the RW material, for example in the first area 12. Then, the location of the first area 12 is encoded, as well as the type information. A stamper is then created, which comprises pits and lands corresponding to said encoded location and type information. In this case, this stamper is not the stamper used for printing grooves on the data carrier, which grooves are printed before the RW material is deposited on the data carrier. The data carrier is embossed with this stamper comprising pits and lands, in order to write the type information of the first area 12 in the type area 11. A reflective material is then deposited on the type area 11.

It should be noticed that the location and the type information of the first area 12 might be written in the type area 11 before writing data in the first area 12. Actually, a stamper is usually used in order to print a groove on the data carrier, which groove is used for tracking. This stamper can be used in order to print pits and lands in the type area 11, which pits and lands comprise the type information of the first area 12. Then, in order to write data on the first area 12, the manufacturer uses a non-conventional recorder, which does not read the type area 11 before writing or does not take the type information into account, so that data can be written in the first area 12 by the manufacturer, although this first area 12 is defined as ROM area.

In a third embodiment, the type information is recorded on the data carrier by means of a frequency modulated wobble. A RW data carrier comprises a wobbled groove, which groove is used for tracking. In a RW disc for example, the disc comprises a spiral shaped groove. This groove is not a perfect spiral, but is wobbled in order to produce information such as timing information, which information can be retrieved by a reading and/or recording apparatus. The wobbled groove cannot be erased by means of an optical beam, because the groove is necessary to write data on the data carrier. In this embodiment, the wobble is used in order to record the type information of the first area 12 on the data carrier. For example, additional information is added to the timing information in the wobble, which additional information correspond to the type information of the first area 12. Further details are given hereinafter, in the examples of a CD-RW and a BD.

The type information can be recorded in the wobbled groove of the type area 11. In this case, when a user wants to write data on the data carrier with a conventional recorder, the recorder first read the type area 11 and thus knows that no data can be written in the first area 12.

The type information can also be written in the wobbled groove of the first area 12. In this case, the data carrier does not comprise the type area 11. In this case, when a user wants to write data on the data carrier with a conventional recorder, the recorder scans the data carrier until finding an area of the disc which is not defined as a ROM area.

In this third embodiment, where the type information is recorded on the data carrier by means of a frequency modulated wobble, the manufacturer uses a non-conventional recorder in order to write data on the first area 12, which recorder does not read the type information before writing or does not take the type information into account, so that data can be written in the first area 12 by the manufacturer, although this first area 12 is defined as ROM area.

A CD-RW disc in accordance with the invention is described hereinafter. As described above, such a CD-RW comprises a wobbled groove. By means of the groove wobble frequency, the CD-RW disc contains motor control information and by means of ATIP (ATIP stands for Absolute Time In Pre-groove), the CD-RW disc contains time-code information. The CD-RW comprises a lead-in area comprising, for example, a table of contents, and a data area comprising a RW material. In FIG. 1, the lead-in area is represented by the type area 11, and the data area by the first and second areas 12 and 13. In the lead-in area, the ATIP data can comprise other information than time-code information. As a consequence, the type information of the first area 12 can be recorded as ATIP data in the lead-in area of the CD-RW disc. This type information is encoded in the ATIP minutes, seconds and frames bytes and is identified by a special combination of the most significant bits of the minutes, seconds and frames bytes. In particular, the combination 011 can be used, which combination is not yet used. Once the type information of the first area 12 has been encoded as ATIP data, the wobbled groove is printed on the data carrier.

A BD disc in accordance with the invention is described hereinafter. Such a BD disc comprises a lead-in zone and a data zone, which comprises a rewritable material. In FIG. 1, the lead-in zone is represented by the type area 11, and the data zone by the first and second areas 12 and 13. The lead-in zone comprises a rewritable zone comprising a wobbled groove, and a non-rewritable zone, comprising a HFM wobbled groove (HFM stands for High Frequency Modulated). The non rewritable zone of the lead-in zone is a pre-recorded zone comprising a Permanent Information and Control data (hereinafter referred as PIC) zone. The PIC zone is pre-recorded with data for various purposes, such as disc information. As a consequence, the type information of the first area 12 can be recorded as PIC data in the lead-in zone of the BD disc. The type information is encoded as PIC data, and the HFM wobbled groove is printed on the data carrier.

In the example of FIG. 1, the first area 12 is located near the central hole 10, and the second area 13 is located in the outer regions of the data carrier. Of course, these locations can be inverted. However, having the first area 12 in the inner regions of the data carrier and the second area 13 in the outer regions of the data carrier is particularly advantageous. Actually, in optical discs, writing in outer regions of a disc requires a lower speed of rotation of the disc than for writing in inner regions of a disc. As a consequence, if a user wants to write data in the second area with a portable device, the amount of power needed is less with the second area located in the outer regions of the disc than with the second area located in the inner regions of the disc. As a consequence, such a data carrier is particularly adapted to use in portable devices, such as a mobile phone or a cordless phone, a palmtop computer, a laptop, a digital camera or a camcorder.

It is important to notice that a data carrier in accordance with the invention can comprise only areas defined as ROM areas. This means that the data carrier depicted in FIG. 1 can comprise only the first area 12 and not the second area 13. In this case, a user cannot write data on the data carrier.

It is also important to notice that a data carrier in accordance with the invention can comprise a plurality of data layers. One of the data layer can be of the type of the data layer as depicted in FIG. 1, i.e. comprising a RW area such as the second area 13 and a RW area defined as ROM area such as the first area 12. Alternatively, one layer can comprise only areas defined as ROM areas, whereas another layer can comprise a RW area not defined as ROM area.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A data carrier comprising a first area (12) comprising a rewritable material, said first area being defined as a read-only area by means of type information recorded on said data carrier in an unerasable way.

2. A data carrier as claimed in claim 1, said data carrier further comprising a second area (13) comprising a rewritable material, said first and second areas being parts of a same layer of said data carrier.

3. A data carrier as claimed in claim 2, said data carrier comprising a central part (10), the first area being nearer to said central part than the second area.

4. A data carrier as claimed in claim 1, said data carrier comprising a type area (11) comprising said type information recorded by means of pits and lands.

5. A data carrier as claimed in claim 1, wherein said type information is recorded by means of a frequency modulated wobble.

6. A rewritable Compact Disc as claimed in claim 5, said disc comprising a lead-in area, said type information being encoded as Absolute Time In Pre-groove data in said lead-in area.

7. A Blu-Ray disc as claimed in claim 5, said type information being encoded as Permanent Information and Control data.
